(19) United States
(12) Patent Application Publication
(10) Pub. No.: US 2015/0022082 A1
(43) Pub. Date: Jan. 22, 2015

(54) Dielectric barrier discharge lamps and methods

(71) Applicant: Brady Hauth, Salt Lake City, UT (US)

(72) Inventor: Brady Hauth, Salt Lake City, UT (US)

(21) Appl. No.: 13/947,087

(22) Filed: Jul. 21, 2013

(51) Int. Cl. H01J 65/04

(52) U.S. Cl. CPC H01J 65/046
USPC 315/39

(57) ABSTRACT

Electric lamps wherein material inside a bulb is excited using capacitive coupling through the bulb wall to external electrodes, forming plasma which emits light. Methods described include use of light-emitting material including sulfur and/or selenium, and a circuit for driving the external electrodes.

### FIELD

The field relates to systems and methods for converting electricity to light, and more particularly to lamps wherein light is emitted primarily by plasma inside a bulb which is electrically excited using dielectric barrier discharge.

### BACKGROUND

Gas-discharge lamps, such as fluorescent lights, use light-emitting plasma in a bulb. The spectrum of light emitted depends on plasma composition. Sulfur can provide a good spectrum for lighting with good efficiency, and it also gives relatively fast startup time, but it cannot be used in a gas-discharge lamp because it reacts with the electrodes used to excite the plasma. For this reason, work on lights using sulfur has largely focused on electrodeless lamps with plasma excited by microwaves generated by a cavity magnetron. However, magnetrons are the limiting factor for the light lifetime, have mediocre efficiency, and are difficult to scale down to power levels appropriate for most lighting fixtures.

“External electrode fluorescent lamps” (EEFLs) are fluorescent lights which use dielectric barrier discharge to excite the mercury plasma. EEFLs have been used for some specialty applications, but have not been competitive with conventional hot-cathode fluorescent lights for general-purpose lighting. The plasma of sulfur lamps has significantly lower conductivity than the plasma of fluorescent lights, leading to increased resistive energy transfer and increased light output. At the same time, using dielectric barrier discharge solves the problem of electrode corrosion in sulfur lamps.

Design of driver circuits for EEFLs has been one issue limiting their adoption. A driver circuit for dielectric barrier discharge lamps is also presented.

### BRIEF SUMMARY OF THE INVENTION

The technical problem which the present invention relates to is conversion of electricity to light by means of electrically exciting material inside a bulb to form and maintain plasma which emits light, and more specifically to such lamps wherein dielectric barrier discharge is the means of excitation. The present invention solves this problem by means of using a relatively high-density plasma including sulfur as the light-emitting material, and by means of a driver circuit for driving capacitive couplings, and by the other means described in the claims.

Advantageous effects of the present invention include making possible the manufacturing of electric lamps with improved combinations of efficiency, light quality, cost, lifespan, startup time, and environmental safety.

### BRIEF DESCRIPTION OF THE DRAWINGS

FIG. 1 illustrates an electric circuit diagram.

FIG. 2 illustrates a bulb with a resistive heating system in top view.

### DETAILED DESCRIPTION OF THE INVENTION

The present invention is not limited to the construction details or component arrangements described in the following description or illustrated in the drawings. Other embodiments of the present invention are possible. The terminology used within is for the purpose of the description and should not be regarded as limiting except to the extent set forth in the claims.

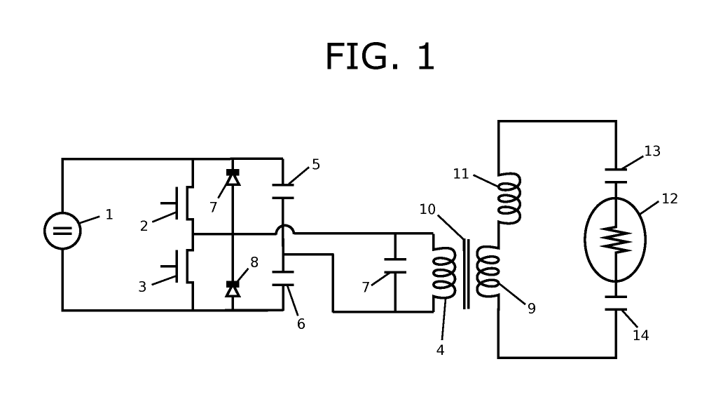

Turning to FIG. 1, a DC power source 1 is switched by power MOSFETs 2 and 3. This power passes through a transformer winding 4 to the center point of capacitors 5 and 6. The capacitors 5 and 6 can also act to smooth input power. A small optional capacitor 7 may be used to reduce switching losses. Optional fast diodes 7 and 8 may be placed in parallel with the MOSFETs to reduce switching losses. The diodes 7 and 8 may be silicon carbide Schottky diodes.

Electrical energy is transferred from transformer winding 4 to transformer winding 9 through a magnetic core 10. The transformer winding 9 is placed in series with an inductor 11. The inductor 11 and transformer winding 9 may be combined by use of a transformer designed such that transformer winding 9 has high leakage inductance. This electrical energy is now transferred through the bulb 12 via capacitive couplings 13 and 14. The capacitors 13 and 14 are formed by: external electrodes on the bulb wall, the bulb wall, and plasma inside the bulb. Electricity travels between the external electrodes through a plasma arc inside the bulb. The external electrodes may be: wire bent into a pattern, metal film, or metal foil. Possible electrode materials include tungsten and chromium.

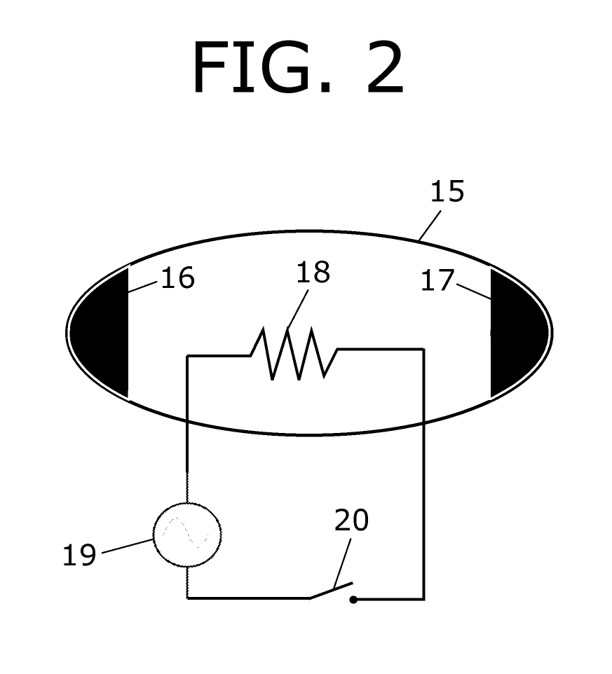

The plasma conductivity may decrease significantly once sulfur and/or other materials inside the bulb vaporize. The higher plasma conductivity before this point may make it difficult to vaporize those materials with only heat from the electrical arc. Turning to FIG. 2, a resistive heating element 18, shown on a bulb 15 with electrodes 16 and 17, is used to heat the bulb during startup. A power source 19 is connected to the heating element 18 through a switch 20. The switch 20 may be a bimetallic strip which is on or near the bulb surface. The resistive heating element 18 may be a thin wire or metal film bonded to the bulb surface. The resistive heating element 18 may wind around the bulb in a spiral pattern.

The resistive heating element 18 can also act as a capacitive coupling to the material inside the bulb, affecting the plasma arc shape during startup. Instead of a resistive heating element, the bulb may have a “guide electrode” consisting of a spiral of conductive material wound around the bulb, which may be electrically isolated or connected to an element with relatively constant voltage. Capacitive coupling to this guide electrode causes the initial electrical arc to follow the guide electrode along the inner surface of the bulb, which may vaporize sufficient material on the bulb's inner surface to facilitate startup of the lamp.

For general-purpose lighting, the partial pressures in the bulb plasma at an average temperature of 3000K preferably include 1 to 40 bar of sulfur. An inert filler, such as argon, is needed to allow creation of an initial arc. Other components or compositions may be used depending on the desired spectrum of light emitted, especially metal halides used in metal halide lamps.

What is claimed is:

1. An electric lamp comprising: a transparent or translucent bulb; material inside the bulb which emits light when electrically excited and which includes sulfur and/or selenium as a vital component; capacitive couplings between electrodes and said material inside the bulb through the wall of the bulb and/or an insulating barrier other than the wall of the bulb, which are electrically driven to create an electric discharge inside the bulb, and which serve as the primary means of energy transfer to material inside the bulb during normal operation after startup; and a drive circuit used to drive said capacitive couplings.

2. An electric lamp comprising: a transparent or translucent bulb; material inside the bulb which emits light when electrically excited; capacitive couplings to the material inside the bulb which are electrically driven to create an electric discharge inside the bulb; and a drive circuit comprising: two capacitors in series across conductors carrying DC input power;
semiconductor switches connecting said conductors to the first connection point of the primary winding of a transformer; a conductor connecting the second connection point of the primary winding of said transformer to the center point of said pair of capacitors in series; an inductor in series with the secondary winding of said transformer; and conductors connecting said capacitive couplings to the ends of said inductor and said transformer secondary winding which are not connected to each other.

3. The electric lamp of claim 2 wherein a capacitor is in parallel with said transformer primary winding in order to reduce switching losses.

4. The electric lamp of claim 1 wherein the bulb contains at least 300 micrograms of sulfur per cubic centimeter.

5. The electric lamp of claim 1 wherein the bulb consists primarily of aluminosilicate glass.

6. The electric lamp of claim 1 wherein the bulb wall thickness is decreased in areas under electrodes relative to other parts of the bulb in order to increase capacitance between those electrodes and material inside the bulb.

7. The electric lamp of claim 1 wherein a resistive heating element is used to heat the bulb during startup in order to vaporize said material inside the bulb.

8. The electric lamp of claim 7 wherein a bimetallic strip is used as an electrical switch for the resistive heating element.

9. The electric lamp of claim 1 wherein a guide electrode on the surface of the bulb causes an electrical arc between two electrically driven electrodes to initially follow a path along the inner surface of the bulb due to capacitance between said guide electrode and plasma inside the bulb, in order to facilitate startup of the lamp.

10. The electric lamp of claim 1 wherein the electricity used to drive capacitive couplings to the bulb is switched primarily by semiconductor switches operating primarily in an on/off switching mode.

11. The electric lamp of claim 10 wherein said capacitive couplings are driven at a frequency between 10 kHz and 40 MHz.

12. The electric lamp of claim 10 wherein the semiconductor switches used are Super Junction MOSFETs.
